(19) United States
(12) Patent Application Publication
(10) Pub. No.: US 2017/0153968 A1
(43) Pub. Date: Jun. 1, 2017

(54) DATABASE CONFIGURATION CHECK

(71) Applicant: SAP SE, Walldorf (DE)

(72) Inventors: Anton Georgiev, Tairnbach (DE); Markus Dobler, Harthausen (DE); Stefan Hoffmann, Dittweiler (DE)

(21) Appl. No.: 14/955,280

(22) Filed: Dec. 1, 2015

(51) Int. Cl. G06F 11/36; G06F 17/30

(52) U.S. Cl. CPC G06F 11/3688; G06F 17/30292; G06F 17/30595

(57) ABSTRACT

A system includes determination of a plurality of database configuration checks, execution of the plurality of database configuration checks against database configuration data to generate, for each of the plurality of database configuration checks, a respective result, display of one of the respective results, the displayed respective result associated with a negative result outcome, and display of information to assist resolution of the negative result outcome.

### BACKGROUND

A typical enterprise database system stores vast amounts of data received from one or more different sources. This data is stored within relational database tables and is accessible via database applications. Some aspects of database operation are governed by configuration properties stored within configuration files.

A database administrator may customize and/or change database operation by changing the values of appropriate configuration properties of one or more configuration files. However, due to the complexity of modern database systems, changing configuration property values may result in errors which inhibit or prohibit database operation. Moreover, correctly debugging these errors can be difficult, particularly if multiple configuration property values have been changed.

It is desirable to provide an intuitive and efficient system to identify database configuration errors. Such a system may also advantageously facilitate correction of such errors.

### BRIEF DESCRIPTION OF THE DRAWINGS

FIG. 1 is a block diagram of a database architecture according to some embodiments.

FIG. 2 comprises a flow diagram of a process according to some embodiments.

FIG. 3 is an outward view of a user interface according to some embodiments.

FIG. 4 is a tabular representation of a portion of a database table according to some embodiments.

FIG. 5 is an outward view of a user interface according to some embodiments.

FIG. 6 is an outward view of a user interface according to some embodiments.

FIG. 7 is a block diagram of an apparatus according to some embodiments.

### DETAILED DESCRIPTION

The following description is provided to enable any person in the art to make and use the described embodiments. Various modifications, however, will remain readily apparent to those in the art.

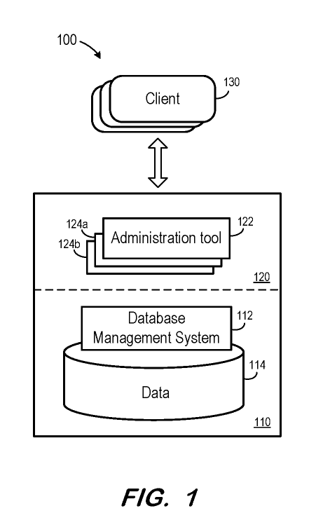

FIG. 1 is a block diagram of database architecture 100 according to some embodiments. Embodiments are not limited to architecture 100 or to a database architecture. Architecture 100 includes database 110, application server 120 and clients 130.

Application server 120 executes and provides services to applications such as administration tool 122 and other applications 124a and 124b. Applications may comprise server-side executable program code (e.g., compiled code, scripts, etc.) which provide functionality to clients 130 by providing user interfaces to clients 130, receiving requests from clients 130 via such user interfaces, retrieving data from database 110 based on the requests, processing the data received from database 110, and providing the processed data to clients 130.

Applications executing within application server 120 such as administration tool 122 may also expose administrative functions to clients 130, including but not limited to database configuration, database maintenance, database optimization, and other administrative functions. Access of a client 130 to particular applications may be based on a role of a user operating the client 130. For example, only users associated with a database administrator role may be permitted to access administration tool 122 in some embodiments.

Application server 120 provides any suitable interfaces through which clients 130 may communicate with applications executing on application server 120. For example, application server 120 may include a HyperText Transfer Protocol (HTTP) interface supporting a transient request/response protocol over Transmission Control Protocol (TCP), a WebSocket interface supporting non-transient full-duplex communications between application server 120 and any clients 130 which implement the WebSocket protocol over a single TCP connection, and/or an Open Data Protocol (OData) interface.

Database 110 comprises database management system (DBMS) 112 and data 114. One or more applications executing on server 120 may communicate with DBMS 112 using database management interfaces such as, but not limited to, Open Database Connectivity (ODBC) and Java Database Connectivity (JDBC) interfaces. These types of applications may use Structured Query Language (SQL) to manage, modify and query data stored in database 110.

Database 110 may comprise any query-responsive data source or sources that are or become known, including but not limited to a SQL relational database management system. Database 110 may comprise a relational database, a multi-dimensional database, an eXtendable Markup Language (XML) document, or any other data storage system storing structured and/or unstructured data. Data 114 may be distributed among several relational databases, dimensional databases, and/or other data sources. Embodiments are not limited to any number or types of data sources.

DBMS 112 serves requests to retrieve and/or modify data 114, and also performs administrative and management functions. Such functions may include snapshot and backup management, indexing, optimization, garbage collection, and/or any other database functions that are or become known. Database 110 may also provide application logic, such as database procedures and/or calculations, according to some embodiments. This application logic may comprise scripts, functional libraries and/or compiled program code.

In some embodiments, data 114 may comprise one or more of conventional tabular data, row-based data, column-based data, and object-based data. Data 114 may be indexed and/or selectively replicated in an index to allow fast searching and retrieval thereof. Database 110 may support multi-tenancy to separately support multiple unrelated clients by providing multiple logical database systems which are programmatically isolated from one another. According to some embodiments, data 114 is distributed among multiple hosts, each host includes one or more partitions, and each partition stores one or more associated database tables of data 114.

Data 114 may also store metadata regarding the structure, relationships and meaning of the data stored within data 114. This information may include data defining the schema of database tables stored within data 114. A database table schema may specify the name of the database table, columns of the database table, the data type associated with each column, and other information associated with the database table.

According to some embodiments, data 114 may include configuration files and configuration check data. Configuration files include properties for configuring database 110 (and possibly application server 120), as a whole and with respect to individual tenant databases, hosts and services. Configuration files may be bundles into sections, each of which includes properties of a same category. Each property may be defined at different layers: default; system-specific; database-specific (e.g., in multi-tenant database systems), and host-specific (e.g., in multi-host database systems).

Configuration check data defines checks which may be applied to configuration files. Configuration check data may generally be used to determine whether configuration files of data 114 are syntactically correct, logically consistent, conform to best practices, are optimized for performance, and/or satisfy any other criteria on which a database configuration may be judged. Each defined check may be associated with a check type, a priority, one or more user roles (i.e., identifying the users authorized to execute the associated check), one or more configuration properties, and values against which to evaluate the one or more configuration properties.

Database 110 may implement an “in-memory” database, in which a full database stored in volatile (e.g., non-disk-based) memory (e.g., Random Access Memory). The full database may be persisted in and/or backed up to fixed disks (not shown). Embodiments are not limited to an in-memory implementation. For example, data may be stored in Random Access Memory (e.g., cache memory for storing recently-used data) and one or more fixed disks (e.g., persistent memory for storing their respective portions of the full database).

As indicated by a dashed line, application server 120 may be separated from or closely integrated with database 110. A closely-integrated application server 120 may enable execution of server applications completely on database 110, without the need for an additional application server. For example, according to some embodiments, database 110 includes a comprehensive set of embedded services which provide end-to-end support for Web-based applications. The services may include a lightweight web server, configurable support for OData, server-side JavaScript execution and access to SQL and SQLScript.

Each of clients 130 may comprise one or more devices executing program code of a software application for presenting user interfaces to allow interaction with application server 120. The user interfaces may comprise user interfaces suited for administration, reporting, data analysis, and/or any other functions based on data 114.

Presentation of a user interface as described herein may comprise any degree or type of rendering, depending on the type of user interface code generated by application server 120. For example, a client 130 may execute a Web Browser to request and receive a Web page (e.g., in HTML format) from application server 120 via HTTP, HTTPS, and/or WebSocket, and may render and present the Web page according to known protocols. One or more of clients 130 may also or alternatively present user interfaces by executing a standalone executable file (e.g., an .exe file) or code (e.g., a JAVA applet) within a virtual machine.

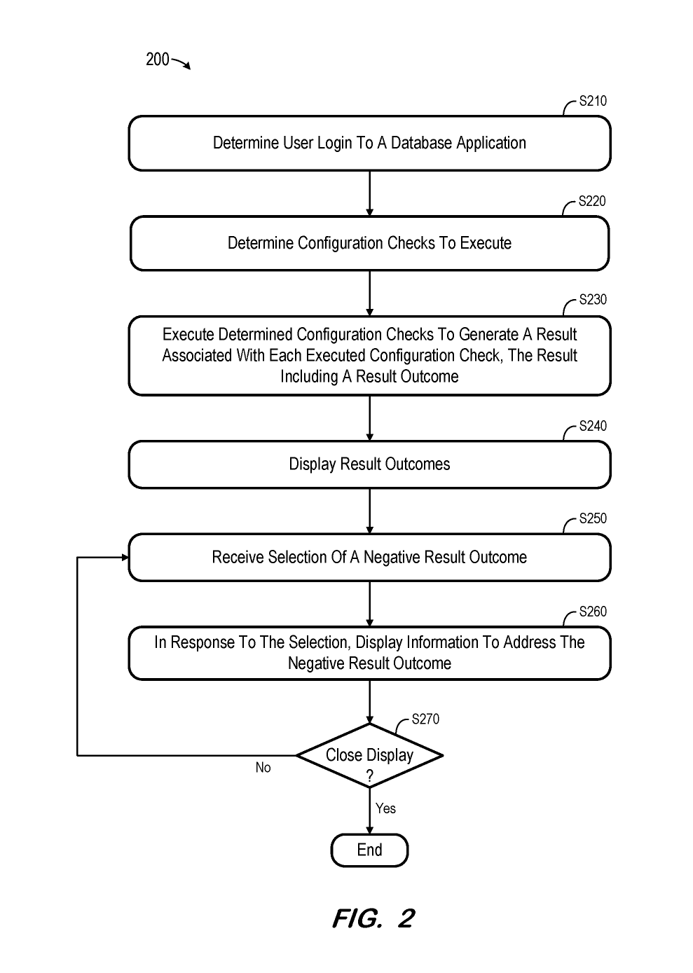

FIG. 2 comprises a flow diagram of process 200 according to some embodiments. Process 200 may comprise a system to check a database configuration according to some embodiments. In some embodiments, various hardware elements of architecture 100 (e.g., one or more processors) execute program code to perform process 200. The program code may be at least partially implemented within administration tool 122 according to some embodiments.

Process 200 and all other processes mentioned herein may be embodied in processor-executable program code read from one or more of non-transitory computer-readable media, such as a floppy disk, a disk-based or solid-state hard drive, CD-ROM, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Initially, a user login to a database application is determined at 5210. For example, a user may operate a client device 130 to access administration tool 122 in order to administer a database system. Assuming the user provides proper credentials, administration tool 122 may transmit a user interface to the client device 130 for display.

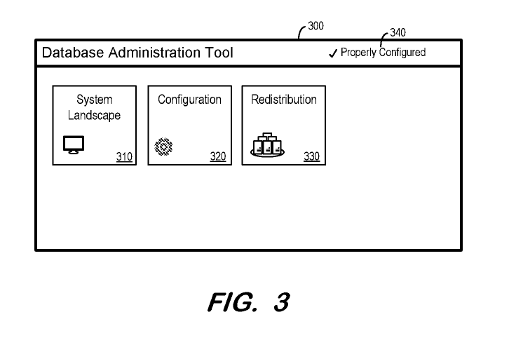

FIG. 3 is an outward view of user interface 300 according to some embodiments. A user may manipulate user interface 300 to manage a database system. User interface 300 includes icons 310-330, which are selectable to access corresponding user interfaces and functionalities of administration tool 122. Indicator 340 indicates that the subject database system is currently properly configured.

The user may select Configuration icon 320 and use subsequently-presented user interfaces to change a configuration associated with the database system. The configuration may include scripts, configuration property values, or any other suitable configuration data. According to some embodiments, a user may use a command line interface provided by administration tool 122 to set or remove configuration property values, using a supported command syntax. Administration tool 122 may comprise any suitable studio, tool, development environment, or other application providing functionality to change a database system configuration.

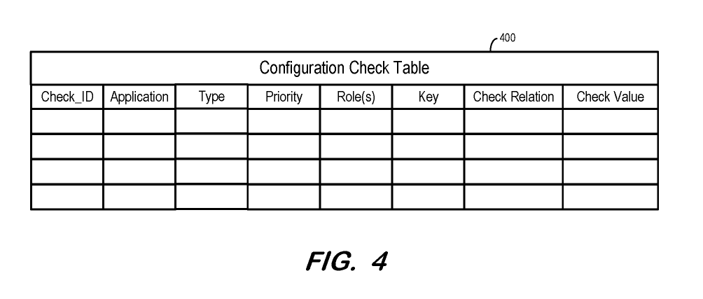

Configuration checks to be executed are then determined at S220. According to some embodiments, the configuration checks are determined at S220 in response to determination of the user login. As described above, configuration checks may be defined by configuration check data according to some embodiments. FIG. 4 is a tabular representation of a portion of configuration check table 400 according to some embodiments. Configuration check table 400 includes data defining one or more configuration checks. The data of table 400 may be used to evaluate database configuration data according to some embodiments.

According to the illustrated schema, to which embodiments are not limited, a configuration check may be associated with an identifying Check_ID, an application, a check type, a priority, one or more user, a key identifying a configuration property, and a value and corresponding relation (e.g., >, <, =) with which to evaluate the key value.

According to some embodiments, the configuration checks to execute are determined at S220 based on the database application to which the user has logged in (e.g., administration tool 122). Determination of the checks may therefore comprise identifying the records of configuration check table 400 which are associated with the application.

According to some embodiments, the database checks are also or alternatively determined based on role of the user. In this regard, each user who logs in to administration tool 122 is associated with at least one role. Determination of the checks may therefore comprise identifying the records of configuration check table 400 which are associated with a role of the user. In some embodiments, records are also identified which are associated with roles whose total authorizations comprise a subset of the user's authorizations.

Next, at S230, the determined configuration checks are executed. Execution of the configuration checks generates a result associated with each executed check. A result may include, for example, a result outcome and other information related to the check to which it corresponds. With reference to table 400, execution of a configuration check may comprise determining whether the value of the associated key (i.e., the configuration property) and the specified check value exhibit the specified relation. The values of the keys may be determined from the configuration files including the configuration data, which may include any changed configuration as described above. If the value of a specified key does not have the specified relation to the specified check value, the result outcome of the check is negative. If so, the result outcome is positive.

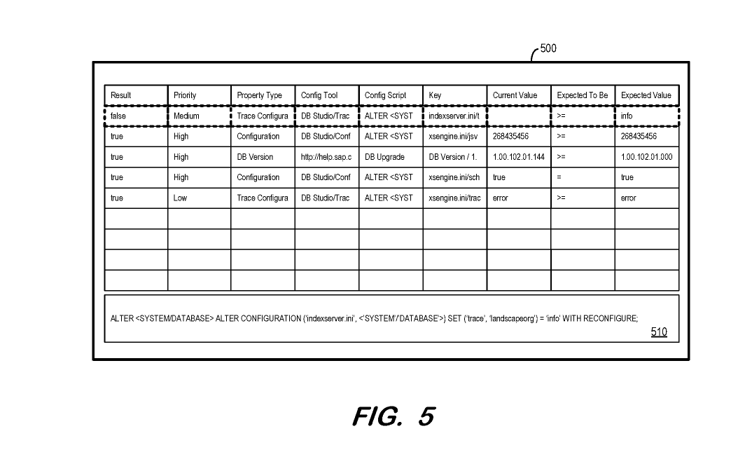

The result outcomes are displayed at S240. FIG. 5 is an outward view of user interface 500 which may be displayed on the client 130 at S240 according to some embodiments. Interface 500 displays the results of five configuration checks, including the result outcomes under the heading “Result”. The Priority column may describe the relative importance of the checked configuration property (e.g., the extent to which proper configuration of the property is mission-critical). Each result also includes a type, a configuration tool suggested to adjust the associated configuration, a configuration script (if any) suggested to be used and executed by the suggested configuration tool to set the associated configuration, a key, a key value (i.e., “Current Value”), check relation (i.e., “Expected To Be), and check value (i.e., Expected Value) as described above. Embodiments are not limited to the form or content of interface 500.

FIG. 5 illustrates selection at S250 of the first row of results, in which the Result value is “false”, referring to a negative result outcome. In response to the selection, area 510 of user interface 500 displays information to address the negative result outcome. According to the illustrated embodiment, the information is a script which, if executed, will correct the configuration problem associated with the first row of results. The user may therefore copy the script from area 510 and again edit the configuration data by including the script therein. The script may be associated with the Check_ID of the check which generated the first row of results, either in a configuration check table such as table 400 or in a separate table. The script may be hard-coded of parameterized, with the parameter values determined based on results returned by the associated check.

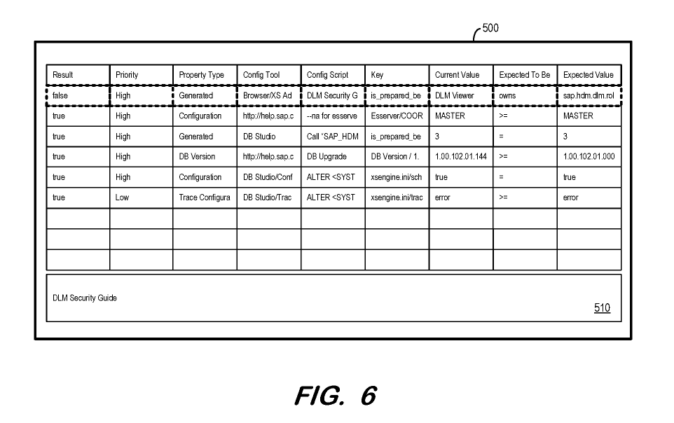

The information displayed at S260 is not limited to a script according to some embodiments. For example, FIG. 6 illustrates a display of result outcomes in which the first row is again associated with a negative (i.e., “false”) result outcome. The first row has been selected at S250, in response to which area 510 displays text identifying related reference material. The text may refer to reference material at any level of generality (e.g., Title, Chapter, Section, Page, Paragraph, etc.), and/or may consist of the reference material itself.

S270 it is determined that the user has not closed the display of results and therefore flow returns to S250 to receive selection of a negative result outcome and to display information to address the negative result outcome. Flow therefore cycles between S250, S260 and S270 until an instruction is received to close the user interface displaying result outcomes.

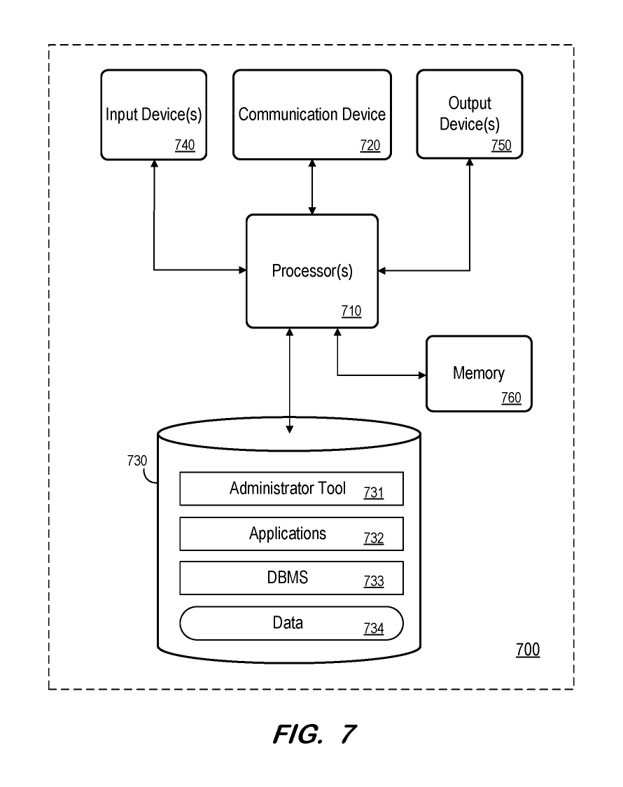

FIG. 7 is a block diagram of apparatus 700 according to some embodiments. Apparatus 700 may comprise a general-purpose computing apparatus and may execute program code to perform any of the functions described herein. According to some embodiments, apparatus 700 may comprise an implementation of database 110 and application server 110 of FIG. 1. Apparatus 700 may include other unshown elements.

Apparatus 700 includes processor 710 operatively coupled to communication device 720, data storage device 730, one or more input devices 740, one or more output devices 750 and memory 760. Communication device 720 may facilitate communication with external devices, such as a client, or an external data storage device. Input device(s) 740 may comprise, for example, a keyboard, a keypad, a mouse or other pointing device, a microphone, knob or a switch, an infra-red (IR) port, a docking station, and/or a touch screen. Input device(s) 740 may be used, for example, to enter information into apparatus 700. Output device(s) 750 may comprise, for example, a display (e.g., a display screen) a speaker, and/or a printer.

Data storage device 730 may comprise any appropriate persistent storage device, including combinations of magnetic storage devices (e.g., magnetic tape, hard disk drives and flash memory), optical storage devices, Read Only Memory (ROM) devices, etc., while memory 760 may comprise Random Access Memory (RAM), Storage Class Memory (SCM) or any other fast-access memory.

Administrator tool 731, applications 732 and DBMS 733 may comprise program code executed by processor 710 to cause apparatus 700 to perform any one or more of the processes described herein. Embodiments are not limited to execution of these processes by a single apparatus.

Data 734 may comprise database tables storing data of database tables, as well as metadata and any other data desired to be stored. Such data may include configuration files including database configuration data, and data defining database configuration checks as described above. Data 734 may be stored in device 730 as shown and/or in volatile memory such as memory 760. Data storage device 730 may also store data and other program code for providing additional functionality and/or which are necessary for operation of apparatus 700, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

1. A system comprising:
a memory storing processor-executable process steps; and
a processor to execute the processor-executable process steps to cause the system to:
determine a plurality of database configuration checks;
execute the plurality of database configuration checks against database configuration data to generate, for each of the plurality of database configuration checks, a respective result;
display one of the respective results, the displayed respective result associated with a negative result outcome; and
display information to assist resolution of the negative result outcome wherein the information comprises a software script that, when executed, corrects a configuration problem associated with the negative result outcome.

2. A system according to claim 1, the processor to further execute the processor-executable process steps to cause the system to:
determine a user login to an application,
wherein determination of the plurality of configuration checks is in response to determination of the user login and based on the application.

3. A system according to claim 1, the processor to further execute the processor-executable process steps to cause the system to:
determine changed database configuration data,
wherein execution of the plurality of database configuration checks against database configuration data comprises execution of the plurality of database configuration checks against the changed configuration data.

4. (canceled)

5. A system according to claim 1, the processor to further execute the processor-executable process steps to cause the system to:
receive a selection from a user of the displayed respective result, and
wherein the information is displayed in response to the selection.

6. A system according to claim 1, the processor to further execute the processor-executable process steps to cause the system to:
display a second one of the respective results, the second displayed respective result associated with a second negative result outcome;
receive a selection from a user of the second displayed respective result; and
in response to the selection of the second displayed respective result, display second information to assist resolution of the second negative result outcome.

7. A computer-implemented method comprising:
determining a plurality of database configuration checks;
executing the plurality of database configuration checks against database configuration data to generate, for each of the plurality of database configuration checks, a respective result;
displaying a first one of the respective results, the first one of the respective results associated with a negative result outcome;
displaying a second one of the respective results, the second one of the respective results associated with a positive result outcome; and
displaying information to assist resolution of the negative result outcome wherein the information comprises a software script that, when executed, corrects a configuration problem associated with the negative result outcome.

8. A method according to claim 7, further comprising:
determining a user login to an application,
wherein determining the plurality of configuration checks is in response to determining the user login and based on the application.

9. A method according to claim 7, further comprising:
determining changed database configuration data,
wherein execution of the plurality of database configuration checks against database configuration data comprises execution of the plurality of database configuration checks against the changed configuration data.

10. A method according to claim 7, wherein the information comprises a software script.

11. A method according to claim 7, further comprising:
receiving a selection from a user of the displayed first one of the respective results, and
wherein the information is displayed in response to the selection.

12. A method according to claim 7, further comprising:
displaying a third one of the respective results, the third displayed respective result associated with a second negative result outcome;
receiving a selection from a user of the third displayed respective result; and
in response to the selection of the third displayed respective result, displaying second information to assist resolution of the second negative result outcome.

13. A non-transitory computer-readable medium storing program code, the program code executable by a computer system to cause the computer system to:
determine a plurality of database configuration checks;
execute the plurality of database configuration checks against database configuration data to generate, for each of the plurality of database configuration checks, a respective result;
display one of the respective results, the displayed respective result associated with a negative result outcome; and
display information to assist resolution of the negative result outcome wherein the information comprises a software script that, when executed, corrects a configuration problem associated with the negative result outcome.

14. A medium according to claim 13, the program code executable by a computer system to cause the computer system to:
determine a user login to an application,
wherein determination of the plurality of configuration checks is in response to determination of the user login and based on the application.

15. A medium according to claim 13, the program code executable by a computer system to cause the computer system to:
determine changed database configuration data,
wherein execution of the plurality of database configuration checks against database configuration data comprises execution of the plurality of database configuration checks against the changed configuration data.

16. A medium according to claim 13, wherein the information comprises a software script.

17. A medium according to claim 13, the program code executable by a computer system to cause the computer system to:
receive a selection from a user of the displayed respective result, and
wherein the information is displayed in response to the selection.

18. A medium according to claim 13, the program code executable by a computer system to cause the computer system to:
display a second one of the respective results, the second displayed respective result associated with a second negative result outcome;
receive a selection from a user of the second displayed respective result; and
in response to the selection of the second displayed respective result, display second information to assist resolution of the second negative result outcome.

19. A system according to claim 1, wherein each of the plurality of database configuration checks is defined by configuration check data to determine whether configuration data are optimized for performance.

20. A system according to claim 1, wherein each of the plurality of database configuration checks is associated with one or more user roles, a check type, a priority, one or more configuration properties, and values against which to evaluate the one or more configuration properties.
